(19) United States
(12) Patent Application Publication
(10) Pub. No.: US 2010/0199762 A1
(43) Pub. Date: Aug. 12, 2010

(54) MICROMECHANICAL DEVICE HAVING A DRIVE FRAME

(76) Inventors: Daniel Christoph Meisel, Vaihingen An Der Enz (DE); Joerg Hauer, Reutlingen (DE)

Correspondence Address: KENYON & KENYON LLP, ONE BROADWAY, NEW YORK, NY, 10004, US

(21) Appl. No.: 12/452,546

(22) PCT Filed: Sep. 26, 2008
(86) PCT No.: PCT/EP2008/062936

§ 371 Date: Apr. 7, 2010

(30) Foreign Application Priority Data
Oct. 12, 2007 (DE) 10 2007 049 341.1
Oct. 29, 2007 (DE) 10 2007 051 591.1

(51) Int. Cl. G01C 19/56

(52) U.S. Cl. 73/504.12

(57) ABSTRACT

A micromechanical device includes at least one drive frame and at least one vibrator, the vibrator being situated in a region surrounded by the drive frame; the vibrator being mechanically coupled to the drive frame. The drive frame is able to be excited to generate a flexural vibration.

### FIELD OF THE INVENTION

The present invention relates to a micromechanical device having at least one drive frame and at least one vibrator, the vibrator being situated in a region surrounded by the drive frame; the vibrator being coupled mechanically to the drive frame.

### BACKGROUND INFORMATION

German Patent Application No. DE 101 08 198 shows a micromechanical rotational rate sensor, which has a drive frame and a vibrator (Coriolis element) situated in it that is mechanically coupled to it. The drive frame executes a drive vibration in the form of an essentially straight-line translatory motion between two reversal points. The drive vibration is transferred to the vibrator using the mechanical coupling. A Coriolis force is able to act on the vibrator as a result of a rotational motion. The effect of the Coiolis force is transferred to the detection element at a sensing element that is connected to the vibrator.

German Patent No. DE 196 17 666 shows a micromechanical rotational rate sensor that is excited by means for excitation of vibration to flexural vibrations, that is, to vibrations having vibration loops and vibrational nodal points. The means for excitation of vibration are situated at the vibration loops. Detection means are situated at the vibrational nodal points.

### SUMMARY OF THE INVENTION

The present invention relates to a micromechanical device having at least one drive frame and at least one vibrator, the vibrator being situated in a region surrounded by the drive frame; the vibrator being coupled mechanically to the drive frame. An important aspect of the present invention is that the drive frame is able to be excited to a flexural vibration. Such a micromechanical device is advantageously created to be compact and to permit a certain vibrational frequency of at least one vibrator.

It is advantageous that drive means are provided at the drive frame for the excitation of the flexural vibration. It is particularly advantageous that the drive means are situated outside the region surrounded by the drive frame. It is of advantage that the drive means are designed for the excitation of the natural vibration of the drive frame. The vibrational frequency is thereby determined accurately, and the drive energy required is low. One advantageous design of the present invention provides that the vibrator be rigidly coupled to the drive frame. In that way, the amplitude of the vibrator is advantageously determined. Another advantageous design of the present invention provides that the vibrator be coupled to the drive frame in a springy fashion. In that way, a large vibrational amplitude of the vibrator may be achieved at a small drive amplitude of the drive means and the drive frame. One advantageous design of the present invention provides that a first drive frame be provided having at least one first vibrator, and that a second drive frame be provided having at least one second vibrator, the two drive frames being mechanically coupled. Another advantageous design of the present invention provides that a first drive frame be provided having a first vibrator and having at least one second vibrator. It is also advantageous that the first vibrator and the second vibrator vibrate in different directions. One particularly advantageous embodiment of the present invention provides that the micromechanical device be a rotational rate sensor, the force effect of a Coriolis force on the vibrator being detectable.

The advantages of the present invention may be summarized as follows. As a result of the present invention, the synchronization of all linear vibrators is advantageously made possible by a drive frame surrounding them, which is excited to flexural vibrations. This drive frame may be a common frame for a plurality of vibrators. This may, however, also involve a plurality of frames coupled to one another, which each have one or more vibrators. In the vibration of the frame, two directions of motion are present, for example, which are separately transferred to two vibrators, so that the latter vibrate perpendicularly (or obliquely) or in whatever other different type of direction to one another. One single drive mode is forced on the micromechanical device via the drive frame. This is particularly advantageously possible if the drive frame is excited to a natural vibration via a drive means. The driving of the vibrator at high amplitude is advantageously possible if the vibrator is coupled to the drive frame at the position of a vibration loop.

The coupling between the drive frame and the vibrator may be made to be rigid or springy. In a rigid coupling, the amplitude of the frame is transferred directly and in an unchanged manner to the vibrator. In a springy coupling, the drive mode of the overall system may be designed in such a way that the frame executes only a small amplitude, whereas the inner vibrator(s) carries/carry out an actually desired drive amplitude by resonant overshoot.

On a surrounding drive frame of a rotational rate sensor, the drive combs of a capacitive drive may be mounted outside, far away from the vibrator and the sensing elements. Because the drive frame only has to vibrate at a small amplitude, the electrode fingers of the drive may be formed to be short. Because of that, the absolute levitation force is reduced. The transfer of the remaining levitation force to the vibrator or the vibrators may be weakened by carrying out the mechanical coupling of the vibrator to the drive frame flexibly, using a coupling spring which performs flexibly in the z direction. In a device according to the present invention, such as the rotational rate sensor according to the exemplary embodiment of FIG. 3 or 5, the following requirements may advantageously be satisfied simultaneously and/or equally:
transfer of the drive amplitude between the vibrators,
transfer of the detection amplitude only between opposite vibrators of respectively an ωₓ, ω_{y} or ω_{z} element,
separation of the parallel mode and the antiparallel mode of the vibrators in the detection,
vibrational modes of the overall vibrator outside the substrate plane (x,y plane), that is, modes in the z direction, have a higher frequency than the usable modes,
generation of two synchronous, perpendicular directions of vibration, whereby a 2-channel and a 3-channel rotational rate sensor having a common drive may be represented.

### BRIEF DESCRIPTION OF THE DRAWINGS

FIG. 1 shows a flexural vibration of a circular frame having two orthogonal directions of vibration.

FIG. 2 schematically shows a first specific embodiment of the micromechanical device according to the present invention.

FIG. 3 schematically shows a second specific embodiment of the micromechanical device according to the present invention.

FIG. 4 schematically shows a third specific embodiment of the micromechanical device according to the present invention.

FIG. 5 schematically shows a fourth specific embodiment of the micromechanical device according to the present invention.

### DETAILED DESCRIPTION

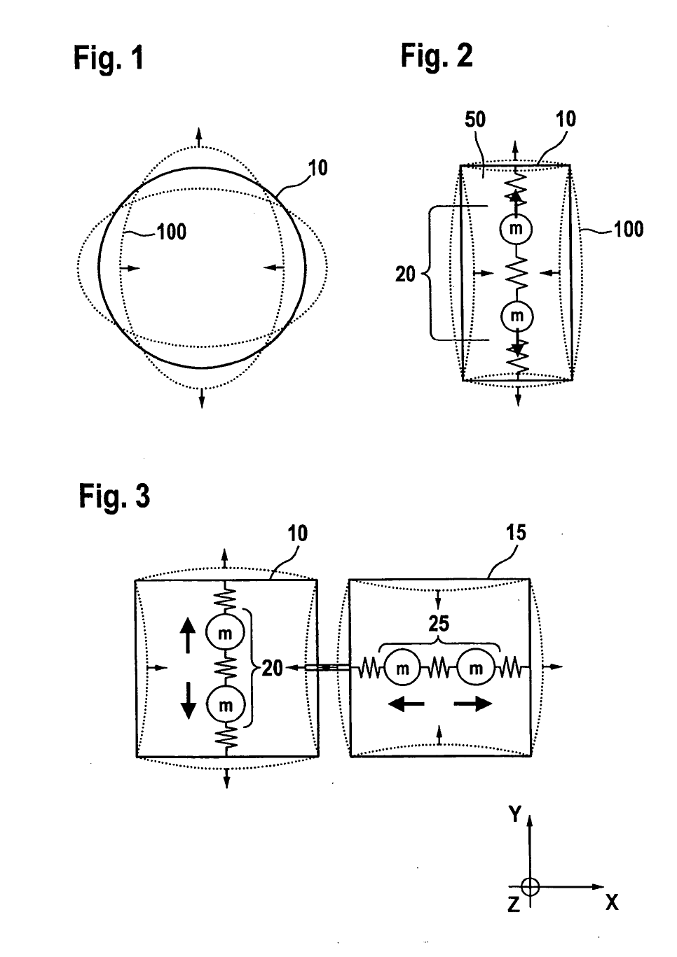

FIG. 1 shows a natural vibration of a circular frame having two directions of vibration that are orthogonal to each other. What is shown is the fundamental mode of flexural vibration 100, that is, a vibration having vibration loops and vibrational nodal points of a circular drive frame 10. The directions of motion of drive frame 10 are symbolized by arrows at the vibrational loops. The micromechanical device according to the present invention has a frame having such properties as drive frame 10.

FIG. 2 schematically shows a first specific embodiment of the micromechanical device according to the present invention. What is shown is a flexural vibration of a rectangular frame having a vibrator 20, in this case a simple mass vibrator on the inside, that is, region 50 that is surrounded by drive frame 10, which is driven by the frame vibration. In the exemplary embodiment according to FIG. 2, outer frame 10 and an inner vibrator 20 are coupled in a springy manner. The principle of the utilization of drive frame 10 for driving vibrators 20 may be extended to two or more adjacent systems which, in turn, are coupled to each other rigidly or in a springy manner, as is shown in the next figure, FIG. 3.

FIG. 3 schematically shows a second specific embodiment of the micromechanical device according to the present invention. A two-frame vibrational system is shown in this exemplary embodiment. In this case, two drive frames 10 and 15 are coupled rigidly to each other at the middle of the edge, using a short transverse beam. Vibrators 20 and 25 are situated in the two drive frames 10 and 15, which vibrate perpendicular to each other in two directions. The device according to the present invention, as in FIG. 3, represents a micromechanical rotational rate sensor having two sensitive axes. The rotational rate sensor is a two-channel element for the detection of ωₓ and ω_{y} rotational rates. The drive motion in the x and the y direction is coupled by the frame (made up of two partial frames 10 and 15 and the connecting coupling crosspiece). The structure shown may be implemented as a micromechanical patterning, particularly as a surface-micromechanical pattern on a substrate. The substrate plane is generated by axes x and y of the coordinate system shown. Axis z is perpendicular to this plane.

A two-channel element for detecting ωₓ and ω_{z} rotational rates is also possible using the above construction.

As is known from the documents named in the related art, the drive (not shown) may be made capacitive as a comb drive. An often undesired side effect of the comb drive is levitation forces, which act in the z direction on the driven movable element, in this case drive frames 10 and 15. The device according to the present invention makes it possible clearly to diminish these levitation forces and their effect.

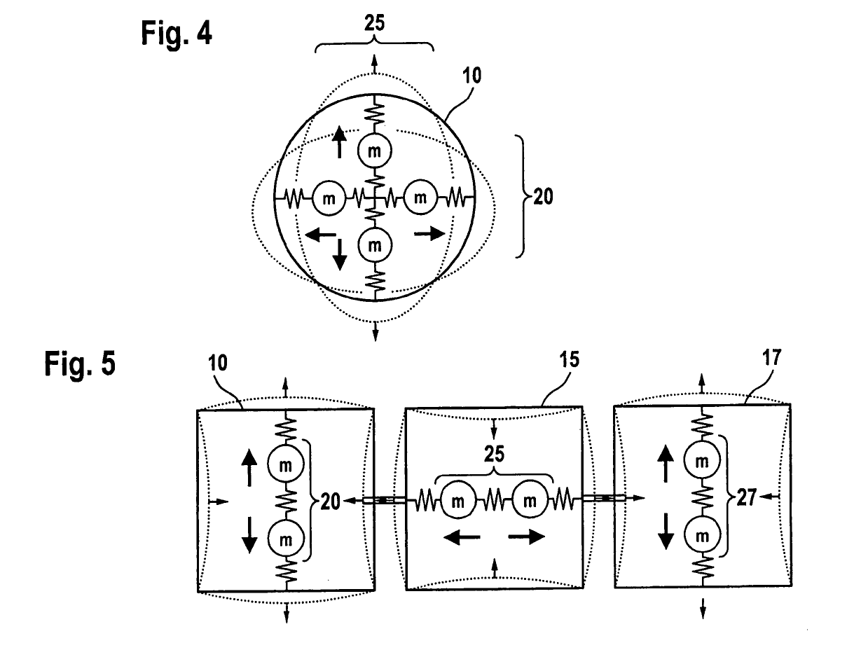

FIG. 4 schematically shows a third specific embodiment of the micromechanical device according to the present invention. In this exemplary embodiment, two vibrators 20 and 25 are situated in one common frame 10.

FIG. 5 schematically shows a fourth specific embodiment of the micromechanical device according to the present invention, similar to the specific embodiment shown in FIG. 3. A three-frame vibrational system is shown in this exemplary embodiment. In this case, two drive frames each, 10 and 15, and 15 and 17, respectively, are coupled rigidly to one another at the middle of an edge, using a short transverse beam. Vibrators 20, 25 and 27 are situated in the three drive frames 10, 15 and 17, and they vibrate perpendicular to one another in two directions. The device according to the present invention, as in FIG. 5, represents a micromechanical rotational rate sensor having three sensitive axes. The rotational rate sensor is a three-channel element for the detection of ωₓ, ω_{y} and ω_{z} rotational rates. The drive motion in the x and the y direction is coupled by the frame (made up of three partial frames 10, 15 and 17, and the two connecting coupling crosspieces). The detection patternings are then in each case designed for the detection of excursions in the substrate plane (x, y) or perpendicular to the substrate plane, that is, for excursions in the z direction.

Other specific embodiments are conceivable, particularly combinations of the exemplary embodiments shown above.

1-11. (canceled)

12. A micromechanical device comprising:
at least one drive frame adapted to be excited to a flexural vibration; and
at least one vibrator, the vibrator being situated in a region surrounded by the drive frame, the vibrator being mechanically coupled to the drive frame.

13. The micromechanical device according to claim 12, further comprising drive means for exciting the flexural vibration at the drive frame.

14. The micromechanical device according to claim 12, further comprising drive means for exciting the flexural vibration, at the at least one vibrator, by which the drive frame is indirectly excitable to the flexural vibration.

15. The micromechanical device according to claim 13, wherein the drive means is situated outside the region surrounded by the drive frame.

16. The micromechanical device according to claim 12, further comprising drive means for exciting a natural vibration of the drive frame.

17. The micromechanical device according to claim 12, wherein the vibrator is rigidly coupled to the drive frame.

18. The micromechanical device according to claim 12, wherein the vibrator is coupled to the drive frame in a springy manner.

19. The micromechanical device according to claim 12, wherein the at least one drive frame includes a first drive frame having at least one first vibrator and at least one second drive frame having at least one second vibrator, the first and second drive frames being coupled mechanically.

20. The micromechanical device according to claim 12, wherein the at least one drive frame includes a first drive frame having a first vibrator and having at least one second vibrator.

21. The micromechanical device according to claim 19, wherein the first vibrator and the second vibrator vibrate in different directions.

22. The micromechanical device according to claim 12, wherein the micromechanical device is a rotational rate sensor for detecting a force effect of a Coriolis force on the vibrator.
